(19) United States
(12) Patent Application Publication
(10) Pub. No.: US 2025/0061272 A1
(43) Pub. Date: Feb. 20, 2025

(54) LANDING PAGE PROCESSING METHOD AND APPARATUS

(71) Applicant: Beijing Youzhuju Network Technology Co., Ltd., Beijing (CN)

(72) Inventors: Donglin Li, Beijing (CN); Wei Zhang, Beijing (CN); Chong Xu, Beijing (CN); Lixin Wang, Beijing (CN)

(21) Appl. No.: 18/725,082

(22) PCT Filed: Feb. 8, 2023
(86) PCT No.: PCT/CN2023/074915

§ 371 Date: Jun. 27, 2024

(30) Foreign Application Priority Data
Feb. 10, 2022 (CN) 202210125592.4

(51) Int. Cl. G06F 40/186

(52) U.S. Cl. CPC G06F 40/186

(57) ABSTRACT

This application discloses a landing page processing method. The method may be, for example, performed by a client. In an example, a user may input a target URL on a certain page of the client, and trigger a landing page generation operation. A page corresponding to the target URL is a material for creating a landing page. After the user triggers the landing page generation operation, the client may obtain the target URL inputted by the user in response to the landing page generation operation. Further, the client may generate a target landing page that matches a page content of a page corresponding to the target URL, and output the target landing page.

### CROSS-REFERENCE TO RELATED APPLICATION(S)

This application claims the priority of Chinese Patent Application No. 202210125592.4, filed with China National Intellectual Property Administration on Feb. 10, 2022, and entitled “LANDING PAGE PROCESSING METHOD AND APPARATUS”, which is incorporated herein by reference in its entirety.

### FIELD

This application relates to the field of data processing, and in particular to a landing page processing method and apparatus.

### BACKGROUND

A landing page refers to a first page that a page jumps to after a user clicks on a certain content. An advertising landing page is a kind of landing page. The advertising landing page refers to a first page that a page jumps to after the user clicks on a certain advertising idea. The advertising landing page may provide the user with advertising guidance information, thereby turning the user from a visitor to a potential customer.

Currently, the user can use a page creation tool to generate the landing page. However, by using the method, the user needs to first learn a use method of the page creation tool, causing that the user operation is complex.

Therefore, there is an urgent need for a solution that may generate the landing page on the premise of simplifying the user operation.

### SUMMARY

The technical problem to be solved by this application is to provide a landing page processing method and apparatus for generating a landing page on the premise of simplifying the user operation.

In a first aspect, embodiments of this application provides a landing page processing method. The method includes:
obtaining a target uniform resource locator (URL) inputted by a user in response to a landing page generation operation triggered by the user;
generating a target landing page that matches a page content of a page corresponding to the target URL; and
outputting the target landing page.

Alternatively, generating a target landing page that matches a page content of a page corresponding to the target URL includes:
obtaining a page content of a page corresponding to the target URL; and
generating the target landing page based on the page content.

Alternatively, generating the target landing page based on the page content includes:
determining a target template that matches the page from a plurality of landing page templates; and
filling the page content into a component corresponding to the target template so as to generate the target landing page.

Alternatively, determining a target template that matches the page content from a plurality of landing page templates includes:
determining the target template from at least one landing page template of the plurality of landing page templates that matches the type of the page.

Alternatively, determining the target template from at least one landing page template of the plurality of landing page templates that matches the type of the page includes:
determining a template in the at least one landing page template that may accommodate a content matching the page content as the target template.

Alternatively, the target template includes one or more of following components:
an image, a video, a text, and a link.

Alternatively, outputting the target landing page includes:
displaying the target landing page, or
displaying a download access corresponding to the target landing page.

Alternatively, the target landing page includes:
an advertising landing page.

Alternatively, obtaining a page content of a page corresponding to the target URL includes:
obtaining structured information of the page corresponding to the target URL; and
performing semantic analysis on the structured information to obtain semantics of the structured information.

Alternatively, the structured information includes one or more of following types of elements:
an image, a video, a text, and a link.

Alternatively, the semantics of the structured information include one or more of following:
a type of the page, a page layout, a page title, an involved product brand, and an image with an importance level exceeding a certain threshold on a page.

In a second aspect, an embodiment of this application provides an apparatus for landing page processing. The apparatus includes:
an obtaining unit, configured to obtain a target uniform resource locator (URL) inputted by a user in response to a landing page generation operation triggered by the user;
a generation unit, configured to generate a target landing page that matches a page content of a page corresponding to the target URL; and
an output unit, configured to output the target landing page.

Alternatively, the generation unit is configured to:
obtain a page content of a page corresponding to the target URL; and
generate the target landing page based on the page content.

Alternatively, generating the target landing page based on the page content includes:
determining a target template that matches the page from a plurality of landing page templates; and
filling the page content into a component corresponding to the target template so as to generate the target landing page.

Alternatively, determining a target template that matches the page content from a plurality of landing page templates includes:
determining the target template from at least one landing page template of the plurality of landing page templates that matches the type of the page.

Alternatively, determining the target template from at least one landing page template of the plurality of landing page templates that matches the type of the page includes:
determining a template in the at least one landing page template that may accommodate a content matching the page content as the target template.

Alternatively, the target template includes one or more of following components:
an image, a video, a text, and a link.

Alternatively, the output unit is configured to:
display the target landing page, or
display a download access corresponding to the target landing page.

Alternatively, the target landing page includes:
an advertising landing page.

Alternatively, obtaining a page content of a page corresponding to the target URL includes:
obtaining structured information of the page corresponding to the target URL; and
performing semantic analysis on the structured information to obtain semantics of the structured information.

Alternatively, the structured information includes one or more of following types of elements:
an image, a video, a text, and a link.

Alternatively, the semantics of the structured information include one or more of following:
a type of the page, a page layout, a page title, an involved product brand, and an image with an importance level exceeding a certain threshold on a page.
In a third aspect, an embodiment of this application provides a device. The device includes a processor and a memory; and
the processor is configured to execute instructions stored in the memory to cause the device to perform the method according to any one of items in the first aspect.

In a fourth aspect, an embodiment of this application provides a computer-readable storage medium, including instructions. The instructions instruct a device to perform the method according to any of in the first aspect.

In a fifth aspect, an embodiment of this application provides a computer program product. The computer program product, when running on a computer, causes the computer to perform the method according to any of in the first aspect.

Compared with the prior art, the embodiments of this application have the following advantages:
embodiments of this application provide the landing page processing method, and the method may be, for example, performed by a client. In an example, the user may input the target uniform resource locator (URL) on a certain page of the client, and trigger the landing page generation operation. The page corresponding to the target URL is a material for creating the landing page. After the user triggers the landing page generation operation, the client may obtain the target URL inputted by the user in response to the landing page generation operation. Further, the client may generate the target landing page that matches the page content of the page corresponding to the target URL, and output the target landing page. It can be seen that by utilizing the solution, if the user wishes to generate the landing page, the user only needs to input the URL of the material for generating the landing page and triggers the landing page generation operation, thereby facilitating the user operation.

### BRIEF DESCRIPTION OF THE DRAWINGS

In order to describe technical solutions in the embodiments of this application or in the prior art more clearly, the accompanying drawings required to be used in the descriptions of the embodiments or the prior art will be briefly introduced below, it is apparent that the accompanying drawings described below are only some embodiments recorded in this application, and those of ordinary skill in the art can obtain other accompanying drawings according to these accompanying drawings without creative work.

FIG. 1 is a schematic flowchart of a landing page processing method according to an embodiment of this application;

FIG. 2 is a structural schematic diagram of an apparatus for landing page processing according to an embodiment of this application; and

FIG. 3 is a schematic structural diagram of a device according to an embodiment of this application.

### DETAILED DESCRIPTION OF EMBODIMENTS

In order to make those skilled in the art better understand the solutions of this application, the technical solutions in the embodiments of this application are clearly and completely described in conjunction with the accompanying drawings in the embodiments of this application as below, and it is apparent that the described embodiments are merely a part rather all embodiments of this application. All other embodiments obtained by those of ordinary skill in the art based on the embodiments of this application without creative efforts shall fall within the scope of protection of this application.

The inventor of this application has found through research that currently, a user may generate a landing page through a page creation tool. However, by using the method, the user needs to first learn a use method of the page creation tool, causing that the user operation is complex. Moreover, by using the method, the efficiency of generating the landing page cannot be guaranteed. Once the user spends too much time learning the page creation tool, the efficiency of generating the landing page will be extremely low.

In order to solve the above problems, embodiments of this application provide a landing page processing method and apparatus, which may generate a landing page on the premise of simplifying the user operation and correspondingly improve the efficiency of generating the landing page.

Various non-limiting implementations of this application are described in detail in conjunction with the accompanying drawings below.

### Exemplary Method

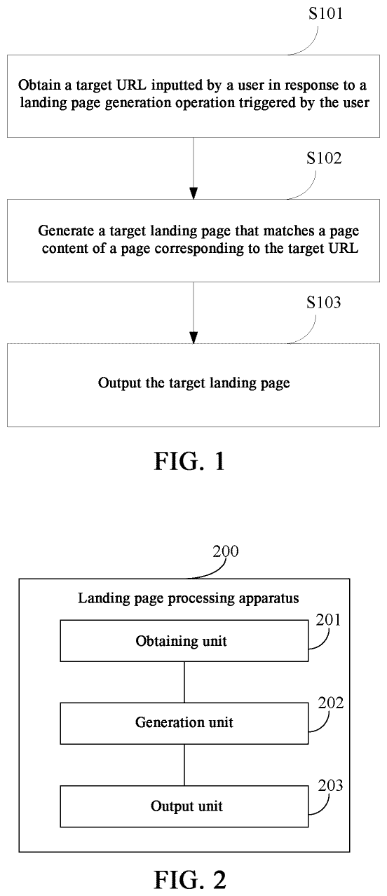

Referring to FIG. 1, FIG. 1 is a schematic flowchart of a landing page processing method according to an embodiment of this application. In this embodiment, the method may be performed by a client or a server side. The embodiments of this application do not impose specific limitations. In the following example, the implementation of the method by the client is used as an example for illustration.

The method shown in FIG. 1 may be, for example, implemented by following steps S101 and S102.
S101: obtaining a target uniform resource locator (URL) inputted by a user in response to a landing page generation operation triggered by the user.
S102: generating a target landing page that matches a page content of a page corresponding to the target URL.

In an example, a page of the client may display a URL input area and a landing page generation control. The user may input a target URL used for providing a material for generating the landing page into the URL input area, and then, the landing page generation control triggers an automatic landing page generation operation. For example, the user may click on the landing page generation control to trigger the automatic landing page generation operation.

After the user triggers the landing page generation operation, the client may obtain the target URL inputted by the user, and after obtaining the target URL, the client may obtain, based on the target URL, the page content of the page corresponding to the target URL, that is, the material for generating the landing page is obtained. The target landing page is further generated based on the material, that is, the target landing page that matches the material is generated.

In examples of this application, when specifically implementing the acquisition of the page content, a web scraping technology may be first utilized for obtaining structured information of the page corresponding to the target URL. The structured information may include, for example, elements of types such as an image, a video, a text, and a link, and size and position information of the various elements. Then, semantic analysis is performed on the structured information to obtain semantics of the structured information. For example, information such as a type of the page, a page layout, and a page title of the page, an involved product brand, and an image with an importance level exceeding a certain threshold on a page, such as a main image are obtained.

The type of the page may include a product page, a form page, an application download page, a personal homepage, etc.

The page layout may include a width and a height of the page, as well as position information and sizes of various elements.

The main image refers to the most important image on the page.

The web scraping technology is a computer software technology for acquiring a page content from a web page, which is not described in detail here.

In an example, the target landing page may be an advertising landing page. In this case, the page content of the page corresponding to the target URL is a material for generating the advertising landing page.

In an example, the client may generate a target landing page that matches the page content through the following steps A to B.

Step A: a target template that matches the page is determined from a plurality of landing page templates.

In this embodiment of this application, the plurality of landing page templates may be predetermined. The plurality of landing page templates may include general templates applicable to a plurality of industries, or may include templates respectively corresponding to the various industries. The embodiments of this application do not impose specific limitations.

In an example, the landing page template may be an advertising landing page template.

In an example, the target template that matches the page may be understood as a template that matches the type of the page and/or the page content. In other words, during specific implementation of step A, the target template that matches the type of the page and/or the page content may be selected from the plurality of landing page templates.

To make the generated target landing page have the best effect, the target template may be a landing page template that matches the type of the page and the page content. In this case, during specific implementation of step A,
at least one landing page template that matches the type of the page may be first determined from the plurality of landing page templates. For example, the type of the page is the product page type, and therefore a product page template from the plurality of landing page templates is determined as the at least one landing page template that matches the type of the page. Then, the target template is determined from the at least one landing page template that matches the type of the page.

The step that the target template is determined from the at least one landing page template that matches the type of the page may be specifically implemented in conjunction with the page content and a content accommodated by the at least one landing page template. In an example, a template in the at least one landing page template that can accommodate a content matching the page content may be determined as the target template. Illustrative examples:

The type of the page is the product page type, and the plurality of landing page templates include two product page templates. One of the product page templates is a single-product page template, and the single-product page template refers to a template that can accommodate information about one product. The other product page template is a multi-product page template, and the multi-product page template refers to a template that may accommodate information about a plurality of products. If the page content includes a plurality of products, the multi-product page template from the single-product page template and the multi-product page template may be determined as the target template.

Step B: the page content is filled into a component corresponding to the target template so as to generate the target landing page.

In this embodiment of this application, the component corresponding to the target template includes any one or more of an image, a video, a text, and a link.

In an example, during specific implementation of step B, an image in the page content may be filled into an image component corresponding to the target template. For example, a main image in the page content is filled into a main image component corresponding to the target template.

In an example, during specific implementation of step B, a video in the page content may be filled into a video component corresponding to the target template. For example, a product introduction video in the page content is filled into a product introduction video component corresponding to the target template.

In an example, during specific implementation of step B, a text in the page content may be filled into a text component corresponding to the target template. For example, a title in the page content is filled into a title component corresponding to the target template; and for another example, a product text introduction in the page content is filled into a product text introduction component corresponding to the target template.

In an example, during specific implementation of step B, a link in the page content may be filled into a link component corresponding to the target template. For example, a product purchase link in the page content is filled into a product purchase link component corresponding to the target template.

S102: the target landing page is outputted.

After generating the target landing page that matches the page content, the client may output the target landing page. In an example, outputting the target landing page may be displaying the target landing page on the client. In another example, outputting the target landing page may be displaying a download access corresponding to the target landing page, and the user may download the target landing page through the download access.

From the above description, it can be seen that by utilizing the solution, if the user wants to generate the landing page, the user only needs to input the URL of the material for generating the landing page and triggers the landing page generation operation, thereby facilitating the user operation.

Meanwhile, the speed of automatically generating the landing page through the client is high, and for the user who needs to spend a lot of time learning the page creation tool, the solution may effectively improve the landing page generation efficiency.

### Exemplary Device

Based on the method provided in the above embodiments, the embodiments of this application further provide an apparatus. The apparatus is introduced in conjunction with the accompanying drawings below.

Referring to FIG. 2, FIG. 2 is a structural schematic diagram of an apparatus for landing page processing according to an embodiment of this application. The apparatus 200 may specifically include, for example: an obtaining unit 201, a generation unit 202, and an output unit 203.

The obtaining unit 201 is configured to obtain a target uniform resource locator (URL) inputted by a user in response to a landing page generation operation triggered by the user;
the generation unit 202 is configured to generate a target landing page that matches a page content of a page corresponding to the target URL; and
the output unit 203 is configured to output the target landing page.

Alternatively, the generation unit 202 is configured to:
obtain a page content of a page corresponding to the target URL; and
generate the target landing page based on the page content.

Alternatively, the step of generating the target landing page based on the page content includes:
a target template that matches the page is determined from a plurality of landing page templates; and
the page content is filled into a component corresponding to the target template so as to generate the target landing page.

Alternatively, the step of determining a target template that matches the page content from a plurality of landing page templates includes:
the target template is determined from at least one landing page template of the plurality of landing page templates that matches the type of the page.

Alternatively, the step of determining the target template from at least one landing page template of the plurality of landing page templates that matches the type of the page includes:
a template in the at least one landing page template that may accommodate a content matching the page content is determined as the target template.

Alternatively, the target template includes one or more of following components:
an image, a video, a text, and a link.

Alternatively, the output unit is configured to:
display the target landing page, or
display a download access corresponding to the target landing page.

Alternatively, the target landing page includes:
an advertising landing page.

Alternatively, the step of obtaining a page content of a page corresponding to the target URL includes:
structured information of the page corresponding to the target URL is obtained; and
semantic analysis is performed on the structured information to obtain semantics of the structured information.

Alternatively, the structured information includes one or more of following types of elements:
an image, a video, a text, and a link.

Alternatively, the semantics of the structured information include one or more of following:
a type of the page, a page layout, a page title, an involved product brand, and an image with an importance level exceeding a certain threshold on a page.

Because the apparatus 200 is an apparatus corresponding to the method provided in the above method embodiments, and specific implementations of various units of the apparatus 200 and the above method embodiments belong to the same concept, for the specific implementations of the various units of the apparatus 200, reference may be made to a description section of the above method embodiments, which will not be repeated here.

The embodiments of this application further provide a device. The device includes a processor and a memory.

The processor is configured to execute instructions stored in the memory, such that the device performs the method according to any of the above method embodiments.

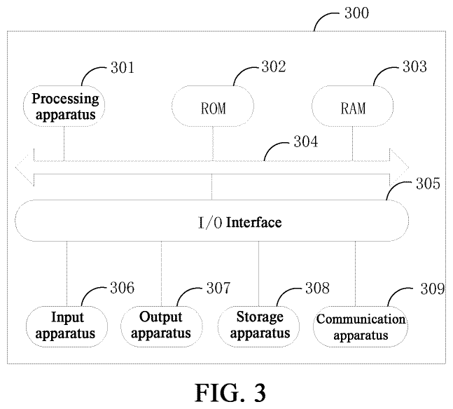

Referring to FIG. 3 below, FIG. 3 illustrates a structural schematic diagram of an electronic device 300 suitable for implementing an embodiment of this application. The electronic device in this embodiment of this application may include, but is not limited to, mobile terminals such as a mobile phone, a notebook computer, a digital radio receiver, a personal digital assistant (PDA), a portable android device (PAD), a portable media player (PMP), and a vehicle-mounted terminal (e.g., a vehicle-mounted navigation terminal), and fixed terminals such as a digital television (TV) and a desktop computer. The electronic device shown in FIG. 3 is merely an example and should not impose any limitations on the functionality and scope of use of embodiments of this application.

As shown in FIG. 3, the electronic device 300 may include a processing apparatus (e.g., a central processing unit and a graphics processing unit) 301 that may perform various suitable actions and processes in accordance with a program stored in a read-only memory (ROM) 302 or a program loaded from a storage apparatus 308 into a random access memory (RAM) 303 In the RAM 303, various programs and data needed by the operation of the electronic device 300 are also stored. The processing apparatus 301, the ROM 302, and the RAM 303 are connected to one another through a bus 304. An input/output (I/O) interface 305 is also connected to the bus 304.

Typically, the following apparatuses may be connected to the I/O interface 305: an input apparatus 306 including, for example, a touch screen, a touch pad, a keyboard, a mouse, a camera, a microphone, an accelerometer, and a gyroscope; an output apparatus 307 including, for example, a liquid crystal display (LCD), a speaker, and a vibrator; the storage apparatus 308 including, for example, a magnetic tape and a hard drive; and a communication apparatus 309. The communication apparatus 309 may allow the electronic device 300 to be in wireless or wired communication with other devices for data exchange. Although FIG. 3 illustrates the electronic device 300 with various apparatuses, it should be understood that it is not necessary to implement or have all the shown apparatuses. Alternatively, more or fewer apparatuses may be implemented or provided.

Particularly, the foregoing process described with reference to the flowcharts according to the embodiments of this application may be implemented as a computer software program. For example, the embodiments of this application include a computer program product including a computer program carried on a non-transitory computer-readable medium. The computer program includes program code for performing the method shown in the flowchart. In such embodiments, the computer program may be downloaded and installed from the network through the communication apparatus 309, or installed from the storage apparatus 308, or installed from the ROM 602. The computer program, when executed by the processing apparatus 301, performs the above functions limited in the method in the embodiments of this application.

The electronic device provided by the embodiments of this application and the method provided by the foregoing embodiments belong to the same inventive concept, and for technical details not described in detail in this embodiment, reference may be made to the foregoing embodiments. This embodiment and the foregoing embodiment have the same beneficial effects.

The embodiments of this application provide a computer-readable medium, having a computer program stored therein. The program, when executed by a processor, implements the method according to any one of the foregoing embodiments.

It should be noted that the computer-readable medium in this application may be either a computer-readable signal medium or a computer-readable storage medium, or any combination of the two. For example, the computer-readable storage medium may include, but is not limited to: electrical, magnetic, optical, electromagnetic, infrared, or semiconductor systems, apparatuses, or devices, or a combination of any of the above. More specific examples of the computer-readable storage medium may include, but are not limited to: an electrical connection with one or more wires, a portable computer disk, a hard drive, a random access memory (RAM), a read-only memory (ROM), an erasable programmable read-only memory (EPROM or a flash memory), an optical fiber, a portable compact disc read-only memory (CD-ROM), an optical storage device, a magnetic storage device, or any suitable combination of the above. In this application, the computer-readable storage medium may be any tangible medium including or storing a program, and the program may be used by or in conjunction with an instruction execution system, apparatus, or device. However, in this application, the computer-readable signal medium may include data signals propagated in a baseband or propagated as a part of a carrier wave, which carry computer-readable program code. Such propagated data signals may take many forms, including but not limited to, electromagnetic signals, optical signals, or any suitable combinations of the above. The computer-readable signal medium may also be any computer-readable medium other than the computer-readable storage medium that may send, propagate, or transmit a program for use by or for use in conjunction with the instruction execution system, apparatus, or device. The program code included in the computer-readable medium may be transmitted by any proper medium including but not limited to a wire, an optical cable, radio frequency (RF), etc., or any suitable combination of the above.

In some implementations, the client and a server can communicate using any currently known or future-developed network protocols such as a hypertext transfer protocol (HTTP), and may also be can be in communication connection with digital data in any form or medium (e.g., a communication network). Examples of the communication network include a local area network (“LAN”), a wide area network (“WAN”), an international network (e.g., Internet), a peer-to-peer network (e.g., an ad hoc peer-to-peer network), and any currently known or future-developed networks.

The computer-readable medium may be included in the above electronic device; and may separately exist without being assembled in the electronic device.

The computer-readable medium carries one or more programs. The one or more programs, when executed by the electronic device, enable the electronic device to perform the above method.

The computer program code for performing the operations of this application may be written in one or more programming languages or a combination thereof. The programming languages include, but are not limited to, object-oriented programming languages such as Java, Smalltalk, and C++, as well as conventional procedural programming languages, such as “C” or similar programming languages. The program code may be executed entirely or partially on a user computer, executed as a standalone software package, executed partially on the user computer and partially on a remote computer, or entirely executed on the remote computer or the server. In the case of involving the remote computer, the remote computer may be connected to the user computer through any type of network, including a local area network (LAN) or a wide area network (WAN), or may be connected to an external computer (e.g., utilizing an Internet service provider for Internet connectivity).

The flowcharts and the block diagrams in the accompanying drawings illustrate system architectures, functions, and operations possibly implemented by the system, the method and the computer program product according to the various embodiments of this application. In this regard, each block in the flowcharts or the block diagrams may represent a module, a program segment, or a portion of code, and the module, the program segment, or the portion of code includes one or more executable instructions for implementing specified logical functions. It should also be noted that in some alternative implementations, functions noted in the blocks may also occur in an order different from that noted in the accompanying drawings. For example, two blocks shown in succession may, in fact, be executed substantially concurrently, or the blocks may sometimes be executed in the reverse order, depending upon the functionality involved. It should be further noted that each block in the block diagrams and/or the flowcharts, as well as a combination of the blocks in the block diagrams and/or the flowcharts may be implemented by using a dedicated hardware-based system that performs specified functions or operations, or using a combination of dedicated hardware and computer instructions.

The units described and involved in the embodiments of this application may be implemented through software or hardware. The name of the unit/module does not limit the unit in certain cases. For example, a voice data acquisition module may be described as a “data acquisition module”.

Herein, the functions described above may be at least partially executed by one or more hardware logic components. For example, without limitation, exemplary hardware logic components that can be used include: a field-programmable gate array (FPGA), an application specific integrated circuit (ASIC), an application specific standard part (ASSP), a system on chip (SOC), a complex programmable logic device (CPLD), etc.

In the context of this application, a machine-readable medium may be a tangible medium that may contain or store a program for use by or for use in conjunction with the instruction execution system, apparatus, or device. The machine-readable medium may be a machine-readable signal medium or a machine-readable storage medium. The machine-readable medium may include, but is not limited to: electronic, magnetic, optical, electromagnetic, infrared, or semiconductor systems, apparatuses, or devices, or any suitable combinations of the above content. More specific examples of the machine-readable storage medium may include: an electrical connection based on one or more wires, a portable computer disk, a hard drive, a random access memory (RAM), a read-only memory (ROM), an erasable programmable read-only memory (EPROM or a flash memory), an optical fiber, a portable compact disc read-only memory (CD-ROM), an optical storage device, a magnetic storage device, or any suitable combination of the above content.

Other implementation solutions of this application can be easily conceived by those skilled in the art after considering the specification and the practice of the present invention disclosed herein. This application is intended to cover any variation, usage, or adaptive change of this application, which follows the general principles of this application and includes common general knowledge or customary technical means in the art that are not disclosed in the present disclosure. The specification and the embodiments are merely to be considered as illustrative, while the true scope and spirit of this application are indicated by the claims below.

It should be understood that this application is not limited to the precise structures described above and shown in the accompanying drawings, and various modifications and changes may be made without departing from the scope thereof. The scope of this application is merely limited by the appended claims.

The foregoing descriptions are merely preferred embodiments of this application, but are not intended to limit this application. Any modification, equivalent replacement, improvement, etc. made within the spirit and principle of this application shall fall within the scope of protection of this application.

1. A method for landing page processing, comprising:
obtaining a target uniform resource locator (URL) inputted by a user in response to a landing page generation operation triggered by the user;
generating a target landing page that matches a page content of a page corresponding to the target URL; and
outputting the target landing page.

2. The method of claim 1, wherein generating the target landing page that matches the page content of the page corresponding to the target URL comprises:
obtaining the page content of the page corresponding to the target URL; and
generating the target landing page based on the page content.

3. The method of claim 2, wherein generating the target landing page based on the page content comprises:
determining, from a plurality of landing page templates, a target template that matches the page; and
filling the page content into a component corresponding to the target template so as to generate the target landing page.

4. The method of claim 3, wherein determining, from a plurality of landing page templates, the target template that matches the page content comprises:
determining the target template from at least one landing page template of the plurality of landing page templates that matches a type of the page.

5. The method of claim 4, wherein determining the target template from at least one landing page template of the plurality of landing page templates that matches the type of the page comprises:
determining a template in the at least one landing page template that accommodates a content matching the page content as the target template.

6. The method of claim 3, wherein the target template comprises one or more of following components:
an image, a video, a text, and a link.

7. The method of claim 1, wherein outputting the target landing page comprises:
displaying the target landing page, or
displaying a download access corresponding to the target landing page.

8. The method of claim 2, wherein obtaining the page content of the page corresponding to the target URL comprises:
obtaining structured information of the page corresponding to the target URL; and
performing semantic analysis on the structured information to obtain semantics of the structured information.

9. The method of claim 8, wherein the structured information comprises one or more of following types of element:
an image, a video, a text, and a link.

10. The method of claim 8, wherein the semantics of the structured information comprise one or more of following:
a page type, a page layout, a page title, an involved product brand, and an image with an importance level exceeding a certain threshold on a page.

11. (canceled)

12. A device, comprising a processor and a memory, wherein the processor is configured to execute instructions stored in the memory to cause the device to:
obtain a target uniform resource locator (URL) inputted by a user in response to a landing page generation operation triggered by the user;
generate a target landing page that matches a page content of a page corresponding to the target URL; and
output the target landing page.

13. (canceled)

14. A computer program product, wherein the computer program product, when running on a computer, causes the computer to:
obtain a target uniform resource locator (URL) inputted by a user in response to a landing page generation operation triggered by the user;
generate a target landing page that matches a page content of a page corresponding to the target URL; and
output the target landing page.

15. The device of claim 12, wherein the device is caused to generate the target landing page that matches the page content of the page corresponding to the target URL by:
obtaining the page content of the page corresponding to the target URL; and
generating the target landing page based on the page content.

16. The device of claim 15, wherein the device is caused to generate the target landing page based on the page content by:
determining, from a plurality of landing page templates, a target template that matches the page; and
filling the page content into a component corresponding to the target template so as to generate the target landing page.

17. The device of claim 16, wherein the device is caused to determine, from a plurality of landing page templates, the target template that matches the page content by:
determining the target template from at least one landing page template of the plurality of landing page templates that matches a type of the page.

18. The device of claim 17, wherein the device is caused to determine the target template from at least one landing page template of the plurality of landing page templates that matches the type of the page by:
determining a template in the at least one landing page template that accommodates a content matching the page content as the target template.

19. The device of claim 16, wherein the target template comprises one or more of following components:
an image, a video, a text, and a link.

20. The device of claim 12, wherein the device is caused to output the target landing page by:
displaying the target landing page, or
displaying a download access corresponding to the target landing page.

21. The device of claim 15, wherein the device is caused to obtain the page content of the page corresponding to the target URL by:
obtaining structured information of the page corresponding to the target URL; and
performing semantic analysis on the structured information to obtain semantics of the structured information.

22. The device of claim 12, wherein the structured information comprises one or more of following types of element:
an image, a video, a text, and a link.
